(19) United States
(12) Patent Application Publication
(10) Pub. No.: US 2002/0042819 A1
(43) Pub. Date: Apr. 11, 2002

(54) System and method to correlate and access related text with locations on an electronically displayed map

(76) Inventors: Ron Reichert, Calgary (CA); Tom Mouat, Salt Spring Island (CA); Bich Hoang, Calgary (CA); Karol Kowalczyk, Calgary (CA)

Correspondence Address: Andrew C. Aitken, VENABLE, Post Office Box 34385, Washington, DC, 20043-9998, US

(21) Appl. No.: 09/961,290

(22) Filed: Sep. 25, 2001

Related U.S. Application Data
(60) Provisional application No. 60/234,785, filed on Sep. 25, 2000.

(51) Int. Cl. G06F 15/16

(52) U.S. Cl. 709/217; 709/203; 707/104.1; 345/744

(57) ABSTRACT

A system and method for the electronic display of a map and textual information relating to destinations on a map is disclosed. The display is provided on a client browser operating in a distributed server computer environment such as the Internet. In response to input from the user of destination and regional paramerers, icons representing a class or classes of destinations that contain embedded functions to enable the user to access textual information related to the destination are displayed on a digital map.

### BACKGROUND OF THE INVENTION

The present invention relates generally to the display of text related to geographical locations on computer networks and, more particularly, to associate such text with a particular geographical location on a client browser operating in a distributed server computer environment such as the Internet. The applicant claims the benefit of the filing date of U.S. application Ser. No. 60/234,785, field on Sep. 25, 2000.

### DESCRIPTION OF THE RELATED ART

Distributing information by the Internet or other publicly accessible computer communication networks has been largely unsupported by advertising revenues due to the lack of good mechanisms for mixing advertising and information content in such a way as to be acceptable to both end users and advertisers. Banner and pop-up advertisements have been correlated to be displayed in response to search information however such advertisements are frequently ineffective because the user is frequently seeking goods or services from a destination within a specific geographical location. Such advertising may be effective for general product recognition and awareness, and in instances where the advertised article or service can be purchased over the Internet. Because most conventional banner displays are designed to be directed to transactions, goods or services which do not require a local presence, local based businesses have little incentive to advertise or promote their respective businesses using the Internet. However, often a prospective purchaser is seeking to locate a particular item or service and then contemplates visiting the location for subsequent purchase. Further, some services business such as the hospitality industry including restaurants, bars and hotels, only offer their respective services at the particular location. Likewise some products are not particularly amenable to sale over the Internet but are best marketed at a physical geographic location.

Maps are now available from a number of Internet web sites that principally comprise graphic information relating to geographic locations. Although maps can provide limited information in the form of text, the amount of the text is abbreviated due to the physical limitations of the medium. In the event that more extensive information is required, some map designers will employ custom maps that are created for a particular purpose. For instance, a business district may produce a map of a limited geographical area and identify the location of those businesses located with a district. Other map-makers catering to tourists may provide the locations of points of interest and restaurants on a map by using a number on a map and an accompanying legend explaining the significance of the numbers. Such custom conventional maps printed on paper can effectively communicate targeted information however are expensive to create and keep current. In view of the space limitations, icons are frequently employed by conventional map-makers to represent significant locations such as public buildings, schools, museums, and other points of interest or destinations. In many circumstances, it is desirable to identify a first destination based upon its proximity to other destinations. Accordingly, the starting point of an individual searching for information relating to destinations is frequently a map.

The Internet is a network of computers which contains the World Wide Web (WWW), as well as other functions such as e-mail. Since the introduction of the WWW, there has been an explosion of growth in the usage of the Internet. Much of this growth has been fueled by the introduction and widespread use of so-called web browsers which allow for a simple graphical user interface based access to network servers which support documents formatted as so-called web pages. The World Wide Web is a collection of servers of the Internet that utilize the Hypertext Transfer Protocol (HTTP). HTTP is a known application protocol that provides users access to files (which can be in different formats such as text, graphics, images, sound, video, etc.), using a standard page description language known as Hypertext Markup Language (HTML). HTML provides basic document formatting and allows the developer to specify “links” or the URL to other servers and files. Use of an HTML-compliant client browser involves specification of a link via a Uniform Resource Locator or “URL.” Upon such specification, the client makes a TCP/IP request to the server identified in the link and receives a web page, namely, a document formatted according to HTML, in return.

There is a need for improved maps that are available on the Internet that can provide specific and detailed information relating to product and services that are principally distributed on a regional basis. There is a further need for improved searching and dissemination of information regarding the existence of products and services that are available within predetermined geographic regions.

### SUMMARY OF THE INVENTION

The present invention provides a system and method for displaying text on the Internet in response to requests for information from a specific location on a map that is presented on a website. The invention also relates to improved manner in which to search for information regarding locations within a predetermined geographical region. In response to a request for specific text-based information associated with a map location, an icon is displayed on an electronic map which contains a control function that allows the user to further access text-based information presented on a window such as advertisements associated with that icon and which may include a new web address that can immediately be retrieved from the window and subsequently, displayed to the user. The search function includes two fundamental search parameters, a first geographical based function that a user may input information such as a street address, zip code, city, town or airport code, and a second target data function, such as a class of destinations. Examples of destination classes may include, restaurants, hotels, bars, and specific retail shops broken down into categories such as hardware, music, hobby stores, clothing, and automobiles. In response to the activation of the search function, a map of the region selected is electronically depicted containing an icon or series of icons responsive to the class destination. In the event that no class destinations are located within the region identified, the search function can automatically increase the area of the geographic map representation until a class destination is located. Each of the icons displayed contains an embedded control function that can be accessed by the user. Information displayed in response to activating the control function designated by the icon may include links to other websites, or provide contact information that relates to the location or may provide advertising or other promotional materials.

According to the invention, within each map displayed to the user a plurality of control functions are provided. The control functions allow the user to proceed from the map to text-based information that relates to the location, and the location of the control function is correlated to the location of the destination on the displayed map. Once the user activates the control function, the text associated with the map is displayed to the user. In the preferred embodiment the text is displayed in an overlay browser window but, in alternative embodiments of the invention, the control function may also consist of a hyperlink, a mouseover that reveals text-based information, or a combination of text-based information, and a hyperlink to a related web page. A mouseover is a location on a display screen that contains a function that reveals text in response to the mouse pointer passing over the location.

The search function may be catered to provide numerous combinations and information relating to a particular geographic location or region. For example, a search may be formulated to locate all hotels and Chinese restaurants within a geographic region. In response to the foregoing search, a map is displayed with generic icons of Chinese restaurants and generic icons of hotels. Each icon that is displayed contains a control function which can be accessed by directing the mouse pointer to the location and, in response to activating the mouse, text-based information is displayed which is correlated to or otherwise relates to the respective icon. An example of such text-based information linked to the icon may include the phone number of the restaurant, the address and the hours of operation. If the location has a website, a link to the website may also be provided. In another example, in the event that a user is searching for a hotel or motel within a specific region, the user provides as input (1) a destination search function for hotels; and (2) a geographic search function. The search program is then initiated in response to the search command and proceeds according to the search input parameters. In an alternative embodiment the manner in which icons are displayed is according to a predetermined hierarchy. For example, if a user initiated a search for hotels within a particular airport code, a preferred hotel chain could either provide proprietary icons with its trademark, or the display could be initially limited to the display of the preferred hotel. Subsequent displays may then be presented that display competing hotels. Accordingly, upon the payment of a preferred fee, certain hotels may be highlighted in association with the hotel search parameter. Thus, although the service provider of the present invention may identify all responsive hotel locations, certain destinations may be offered on an exclusive basis, or certain destinations may be displayed with the proprietary logo icons in response to a generic search upon payment of compensation to the service provider. The service provider may also obtain compensation from the destination wherein the amount of compensation is based upon the number of instances a user activates a hyperlink to the particular destination.

The placement of the icon or “activation button” representing the location of the control functions is preferably at or near the actual geographic location of the destination on the map. As referred to above, the graphic representations may be generic icons related to a particular type of location which generally provide personal services or other services which require physical visits to the location. Additional examples of such destinations include food stores and restaurants, gas, bars, beauty salons, shopping locations, hotels, government service establishments, parks, golf courses, home furnishing stores, theatres, donut stores, bagel stores, convenience stores, hardware stores, hospitals, and camping facilities.

In an alternative embodiment, the Internet web site is constructed in manner for authorized users to place their own link to an electronically displayed map according to certain predetermined criteria. For example, a map may be created to identify a garage sale, yard sale or tag sale in a particular region that will occur on a particular weekend. Any authorized user would be permitted to post an icon that contains a control function at the location on the electronic map. Accessing the control function would allow a viewer to gain access to other text-based information such as the street address, phone number, hours of operation, and featured items at the sale. The authorized user would be free to provide their own custom text-based information that is accessed by the control function. Accordingly, a member of the public could conduct a search wherein only predetermined criteria would be displayed and the viewer could then access further information relating to the selected icon.

The foregoing invention is particularly amenable for the communication of products and services that are available and primarily distributed on a local or regional level. Consumers in search for many products and services such as yard sales, used cars, and services, typically want to limit the scope of their search to defined geographic areas. Such consumers are not intentional in the existence of products and services outside of the target region because the journey to the destination is overly burdensome. A further application of the invention is to provide information relating to the identification and times of movies playing in movie theatres within certain geographic regions.

### BRIEF DESCRIPTION OF THE DRAWINGS

FIG. 1 depicts a data processing system in which the present invention may be implemented.

FIG. 2 is a block diagram illustrating a data processing system in which the present invention may be implemented.

FIG. 3 is a block diagram depicting a pictorial representation of a distributed data processing system in which the present invention may be implemented.

FIG. 4 is a browser window display that can receive input from a user including location and destination parameters.

FIG. 5 is an illustration of a browser window display of an electronic map with text associated with a destination on the map.

FIG. 6 is an illustration of a browser window display of an electronic map having multiple icons and a single overlay window containing text-based information that is associated with an icon.

FIG. 7 is an illustration of a browser window display of an electronic map that also depicts a single class of destination icons.

FIG. 8 is an illustration of a browser window display of an electronic map that also depicts multiple classes of destination icons.

FIG. 9 is a schematic of a browser window display of an electronic map and information that can be correlated with the map locations.

FIG. 10 is a schematic of the flow of information between a user and the provider including the map server and destination information database.

FIG. 11 is a schematic of the network in which the system works.

### DETAILED DESCRIPTION OF THE INVENTION

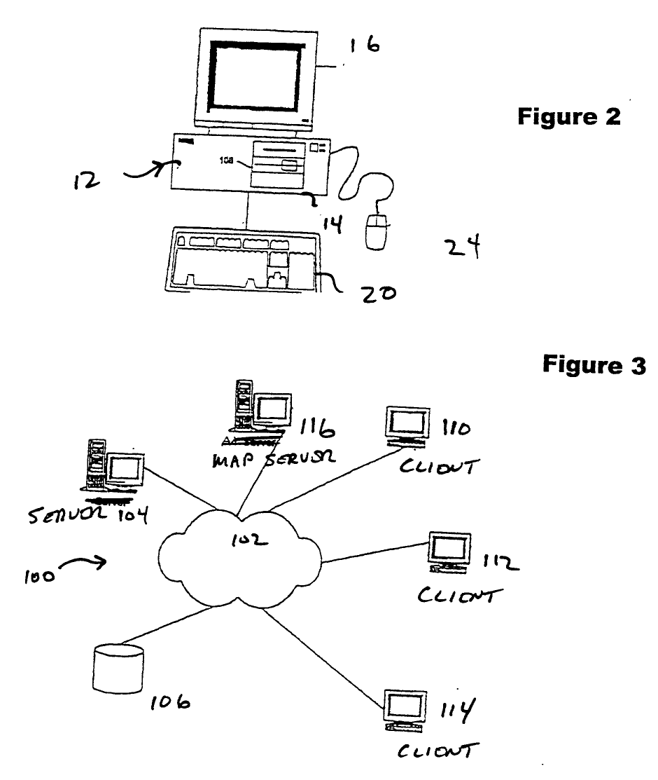

Referring now to FIG. 2, a data processing system in which the present invention may be implemented is shown. A personal computer 12 is depicted which includes a system unit 14 containing a processor, a video display terminal 16, and a keyboard 20. The system unit 14 may include storage devices such as disk drives and other types of permanent and removable storage media. In addition to keyboard 20, input may be provided by and mouse 24. The invention may be implemented using any suitable personal computer, or other types of data processing systems, such as network computers, web-based television set top boxes, and Internet appliances, etc.

FIG. 2 is a block diagram which illustrates a data processing system in which the present invention may be implemented. Data processing system 50 is an example of a client computer. Data processing system 50 uses a peripheral component interconnect (PCI) local bus architecture. Although the depicted example employs a PCI bus, other bus architectures such as Micro Channel and ISA may be used. Processor 52 and main memory 54 are connected to PCI local bus 56 through PCI bridge 58. Additional connections to PCI local bus 56 may be made through direct component interconnection or through add-in boards. In the example depicted, Local Area Network (LAN) adapter 60, SCSI host bus adapter 62, and expansion bus interface 64 are connected to PCI local bus 56 by direct component connection. In the processing system illustrated, audio adapter 68, graphics adapter 70, and audio/video adapter 219 are connected to PCI local bus 56 by add-in boards which have been inserted into expansion slots. Expansion bus interface 64 provides a connection for inputs including the keyboard and mouse adapter 72, modem 74, and additional memory 76. SCSI host bus adapter 62 provides a connection for hard disk drive 80, tape drive 82, and CDROM drive 84.

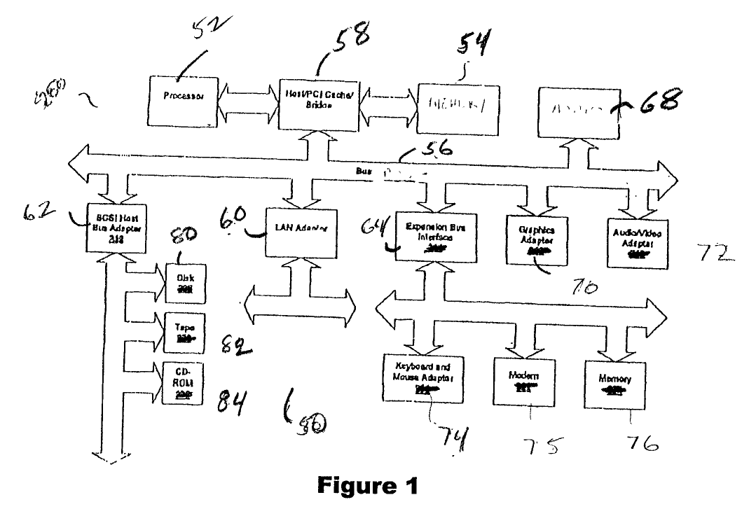

An operating system runs on processor 52 and is used to coordinate and provide control of various components within data processing system 50 in FIG. 1. An object oriented programming system such as Java may run in conjunction with the operating system and provides calls to the operating system from Java programs or applications executing on data processing system 50. “Java” is a trademark of Sun Microsystems, Inc. Instructions for the operating system, the object-oriented operating system, and applications or programs are located on storage devices, such as hard disk drive 80, and may be loaded into main memory 54 for execution by processor 52.

Data processing system 50, may be optionally configured as a network computer. In the network configuration the system may not include SCSI host bus adapter 62, hard disk drive 806, tape drive 82, and CD-ROM 84. In order for the local computer to access the map server and text-based information relating to the map locations, the system must include some type of network communication interface, such as LAN adapter 60 or modem 75.

FIG. 3 is a block diagram that sets forth a pictorial representation of a distributed data processing system in which the present invention may be implemented. Distributed data processing system 100 is a network of computers in that are connected to one another via a communications link such as a modem or LAN. Distributed data processing system 100 contains a network 102, which is the medium used to provide a communication links between various devices and computers connected together within distributed data processing system 100. Network 102 may be made up of permanent connections, such as wire or fiber optic cables, temporary connections made through telephone connections or networks which employ wireless technology or a combination of any of the above.

In the depicted example, a server 104 is connected to network 102 along with data storage unit 106. Clients 110, 112, and 114 also are connected to a network 102. The clients may be, personal computers or network computers. For purposes of this application, a network computer is defined as any computer, coupled to a network, which receives a program or other application from another computer coupled to the network. In the depicted example, server 104 provides data, such as boot files, operating system images, and applications to clients 110-114. Clients 110-114 are clients to server 104. Distributed data processing system 100 may include additional servers, such as map server 116, which provides data that depicts a graphic representation of a map to a user in response to the input request and that contains a plurality of control functions within the representation of the map at certain X and Y coordinates. Information relating to the control functions may be present on a separate server that is activated in the event that any responsive text-based content information is responsive to the location set forth in the depicted map. If the number of control functions (or text-based information) responsive to the input are greater or less than a predetermined number on a particular map, the scale of the map location can be accordingly adjusted.

In the depicted example and in the preferred embodiment, distributed data processing system is the Internet with network 302 representing a worldwide collection of networks and gateways that use the TCP/IP suite of protocols to communicate with one another. The Internet is made up of high-speed data communication lines between major nodes or host computers, consisting of thousands of commercial, government, educational, and other computer systems that route data and messages. Although the preferred embodiment of the invention operates on the Internet, the distributed data processing system also may be implemented as a number of different types of networks, such as, for example, an intranet, a local area network (LAN), or a wide area network (WAN).

The Internet, is a set of computer networks, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols. Currently, the most commonly employed method of transferring data over the Internet is to employ the World Wide Web environment, also called simply “the Web.” Although there are other Internet resources for transferring information, such as File Transfer Protocol (FTP) and Gopher, these other techniques have not achieved the popularity of the Web. In the Web environment, servers and clients affect data transaction using the Hypertext Transfer Protocol (HTTP), a well known protocol for handling the transfer of various data files including text, still graphic images, audio, and motion video, etc. Information is formatted for presentation to a user by a standard page description language, the Hypertext Markup Language (HTML). In addition to basic presentation formatting, HTML allows developers to specify “links” to other Web resources, usually identified by a Uniform Resource Locator (URL). A URL is a special syntax identifier defining a communications path to specific information. Each logical block of information accessible to a client, called a “page” or a “Web page,” is identified by a URL.

The URL provides a universal consistent method for finding and accessing this information, not necessarily for the user, but mostly for the user's Web “browser.” A browser is a software application for requesting and receiving contents from the Internet or World Wide Web. Usually, a browser at a client machine, such as clients 110-112 and 114, submits a request for information identified by a URL. Retrieval of information on the Web is generally accomplished with an HTML-compatible browser. The Internet also is widely used to transfer applications to users using browsers. With respect to commerce on the Web, consumers and businesses use the Web to purchase various goods and services. In offering goods and services, some companies offer goods and services solely on the Web while others use the Web to extend their reach. Information about the World Wide Web can be found at the Web site of the World Wide Web Consortium at http://www.w3.org.

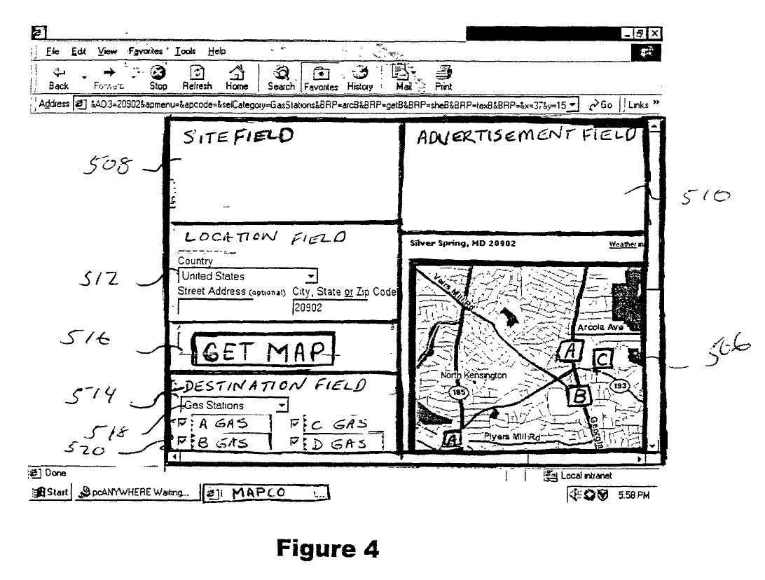

FIG. 4 depicts a browser view that includes a map field 506, a site field 508, an advertisement field 510, a location field 514 and a control field 516. The user enters data relating to a geographic location in location field 512 such as an address, zip code, airport code, city or town and also provides input from a predetermined list of class destinations 518 from destination field 514. Examples of class destinations may include restaurants, hotels, parks, service stations and shopping centers. The user may also be provided with subclass field 520 within destination field 514. In this regard, certain class destinations may be further classified into subclasses. For example, under the restaurants destinations class, a user may be provided with a subclass selection such as Italian, Chinese or French. In other embodiments the user may select a particular name brand establishment. The content provider may also enter into an agreement with a particular brand restaurant and display a proprietary logo whenever the user accesses the restaurant class with the map regardless of the subclass selected. It is further contemplated that in some circumstances an agreement could be arranged so that whenever a particular map is accessed, the map is sponsored by a particular establishment and the icon or icons associated with the sponsor would be displayed regardless of the destination selected by the user. A conventional banner advertisement field 510 can also be integrated with a search function page, and advertising that is displayed with the banner advertisement can be correlated with the nature of the user's input. For example if the user provides input for the destination restaurants, a banner advertising display for a particular restaurant may be displayed in conjunction with the map containing restaurant destination icons. Upon entry of the input information, the control function in 516 is accessed that selects a map and any responsive destination from the map servers and destination server. The information is then downloaded in the form of a map to the user in the map field 506. In the example depicted in FIG. 4 the user has selected zip code 20902 and identified gas stations in the destination field as a class. In the subclass field the user has selected gas stations “A,” “B,” “C.” and “D.” In response to the input, the map displayed 506 depicts icons for A, B and C at the address the respective gas station is located. No D icon is displayed because there is no responsive location within the geographic or location field.

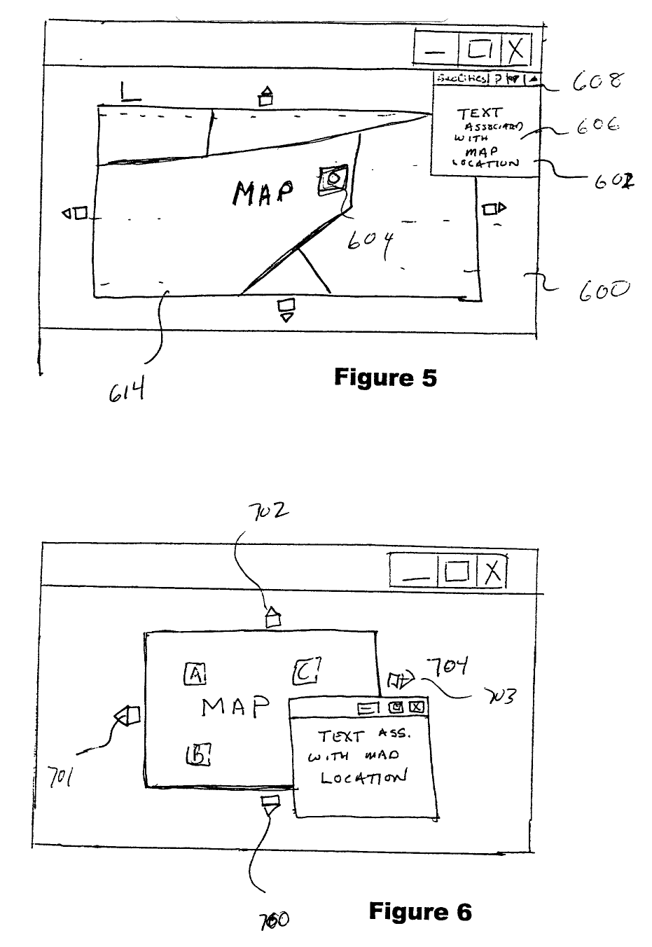

Now referring to FIG. 5, a browser window 600 is shown with a separate browser window 602 that is opened by activation of icon 604. Map 614 has been presented that contains a single icon 604. Browser window 604 contains a new page view with text-based information 606 that relates to the geographic location and which is presented to the user at icon 604. In this first embodiment the user may cancel the text-based information by moving the mouse cursor to the title bar 608 to minimize or delete the overlay window (or use Alt F4 to close the window) and return to the map. In an alternative embodiment of the invention, the icon itself contains a hyperlink that is accordingly embedded in the map at the location of the icon. Activation of the hyperlink takes the user to a new Web page that may be sponsored by the destination. The user can return to the previous page by using the go-back function in the browser.

FIG. 6 shows an alternative method of displaying the text using an overlay browser window. Icon 700, 701 702 and 703 allows the user to scroll the map in a north, south, east and west direction. In the preferred embodiment of the invention, activation of the icons that allow for scrolling of the map requests a new map from the map server that include the same destination class and destination subclass icon control functions.

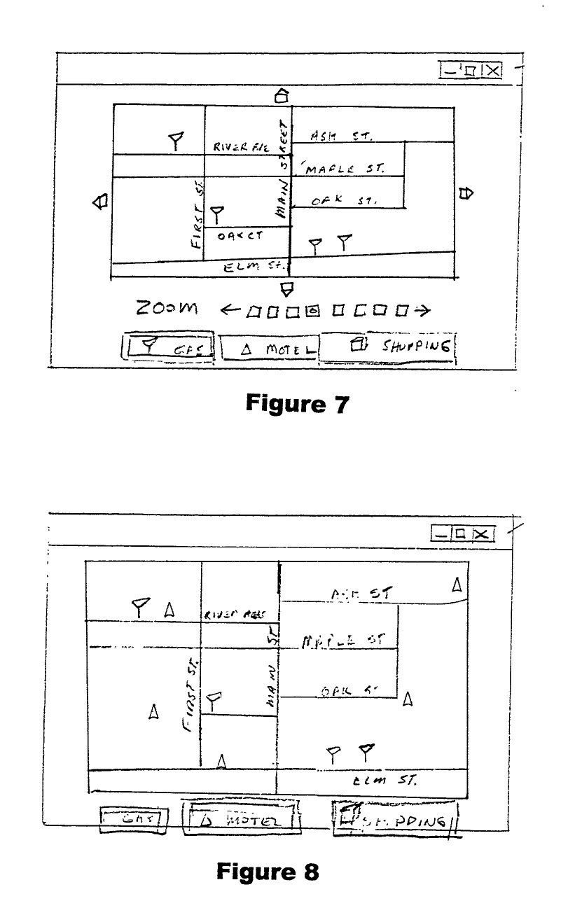

FIGS. 7 and 8 shows a further embodiments of the invention that further incorporates reference keys for the selected destination location or locations. The use of reference keys allows the display of generic icons or symbols that do not have meaning to the user. The keys also may remind the user what destination input has been selected.

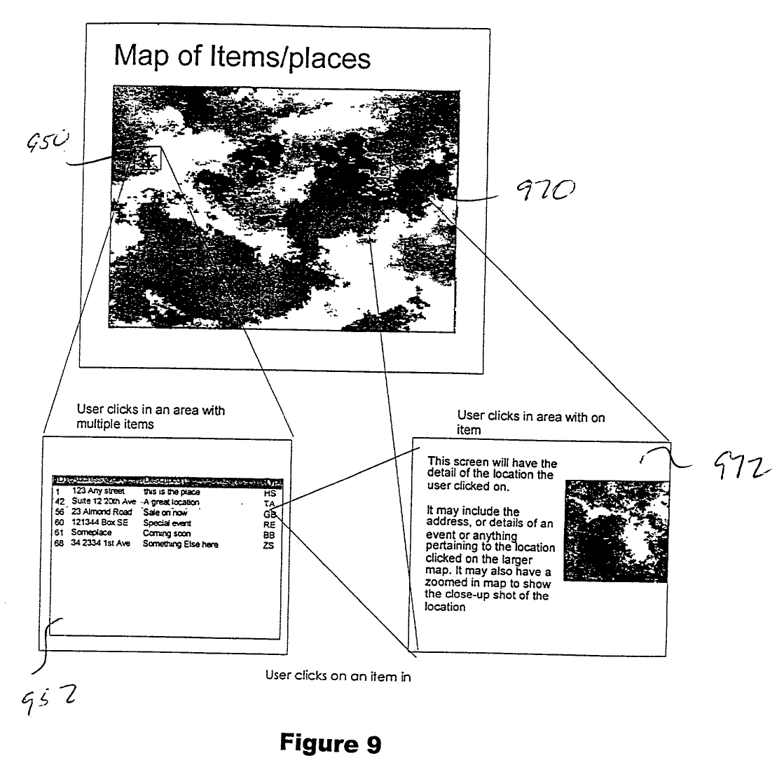

FIG. 9 depicts a map display wherein multiple icons are displayed in a particular region. According to this feature of the invention, the region 950 controls a single control function that is linked to numerous text-based information in the browser page 952 having a number of sub-destinations that has information and may further be linked to other browser pages. Destination 970 is a single location within the region that has text related to the single destination. The linked information may further consist of a detailed map depicted in a limited geographic region.

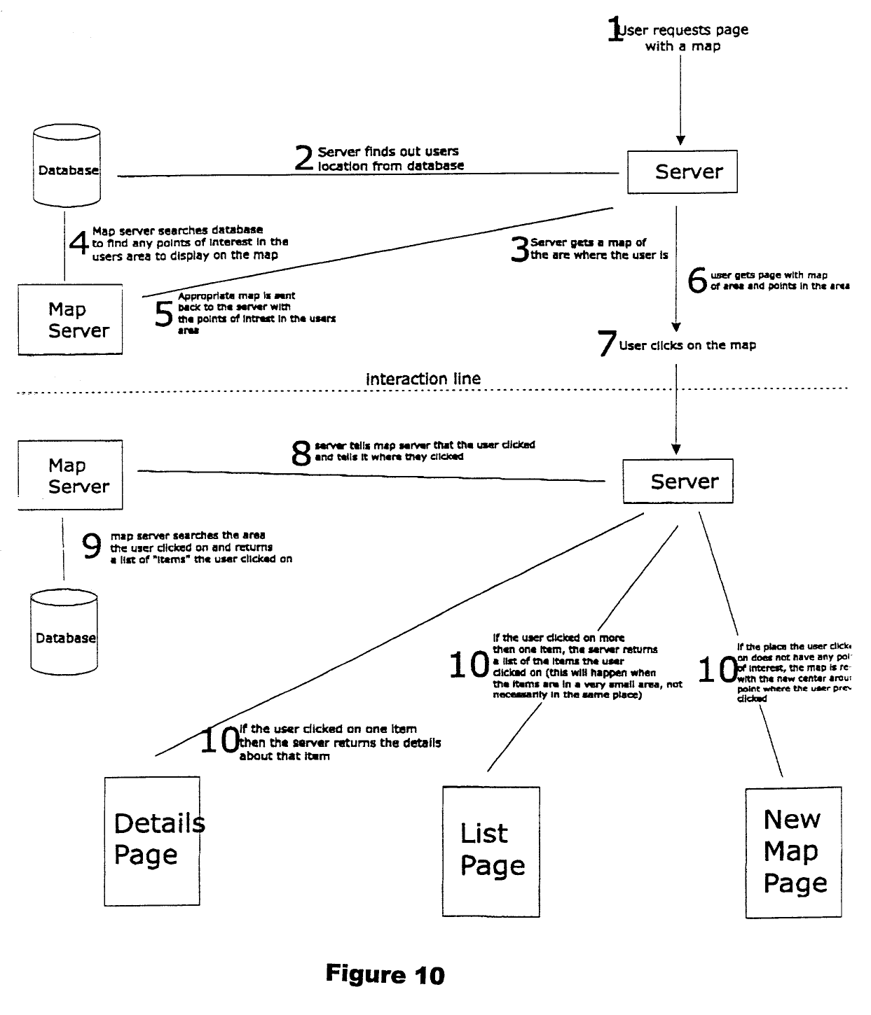

FIG. 10 depicts the flow of information in response to a user's request for information. In an example of the invention, a user inputs information relating to a geographical region and a class destination consisting of points of interest. The server then locates a map in response to the input relating to the users geographic location. The server then searches a database for “points of interest” that are located within the confines of the geographic location. This search function may be achieved by a variety of parameters including zip code, address, or the longitude and latitude coordinates of the respective points of interests. The server then displays a map to the user that includes an icon depicted for all of the respective points of interest and the respective locations of the point of interest on the map. Each icon depicted also contains an embedded control function. The user may then activate the control function by aligning the mouse pointer icon on a selected icon and clicking on the location.

According to an alternative embodiment, the user may select a particular geographic region with the mouse pointer. This region may be displayed by the mouse pointer itself such as by the presentation of a moveable rectangular or circular search field. In response to the activation by a user, the map server determines what icon or icons were located within the geographic search field and displays a list of destinations that were located within the search field within a new browser window. This feature allows a user to select multiple icons representing multiple destinations within a narrow geographic region and be provided with text-based information relating to those items.

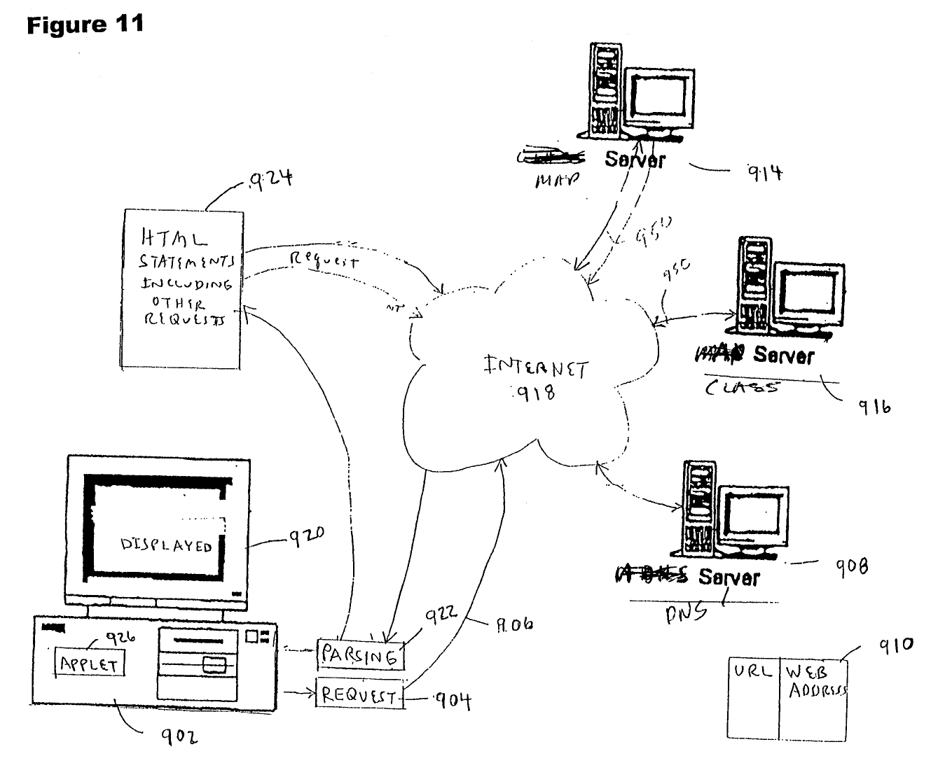

FIG. 11 depicts the flow of information according to an embodiment of the invention that includes different servers that contain mapping information.

The present invention is accordingly directed at methods to increase the content and information to the user that is associated with a particular geographic location on a map. The system will work on any computer driven mapping system. The icons for the system are independently generated by a separate computer database for each map view and can be placed within any computer-generated-map to locate a specific destination or point of interest. The user viewing the map on a conventional desk-top screen or other visual monitoring device is provided with a display that includes these icons. The icons that are displayed can be any visual indicia and may comprise text, logos, symbols signs or pictures. According to the invention, a link or control function is provided on the screen at the coordinate where the icon is displayed. When the user clicks the control function, a connection is made and the user is redirected to a new web page view. This web page may be called up as a hyperlink connection to another web page, a connection to a text box or table, or a connection to any other displayable format. In the new page view, the user is provided with information relating to the location. More than one event or piece of information can be displayed when an icon is activated. For example, if an icon for a gas station is activated the, a browser window can open that will provided information relating to location, services, hours of operation, mechanics schedules, and payment methods accepted. The browser window can also contain further links such as an e-mail address or direct telephone connection to the location. The provision of such information facilitates the sale and reservations of services. In another example, a user with GPS capability may secure the services of a taxi by clicking on a taxi icon. The user can directly communicate to the taxi dispatcher information such as his or her location, and the requested pick-up time. In another example, a user can access the icon of a hotel and view text that may display rates, amenities and vacancy. The user could quickly make reservations using the system or simply be provided important contact information such as the address and phone number. In a second embodiment of the invention, the hyperlink to proceed to the desired page is located at the control function or icon that is presented to the user at the map location. In yet further embodiments the browser's window displayed may provide links to and including the web page address. By providing limited numbers of fields at the icons that only contain predetermined information that is consistently displayed, the user can quickly and efficiently make purchasing decisions. For example, a first browser window for a hotel icon may be provided with a seasonal rate, vacancy, address and phone number, and a link to a web site that may provide additional advertising and provide a detailed description of amenities. Such information would allow prospectives to quickly make decisions with respect to securing hotel reservations.

An example of a program for locating a link or control function within a map is set forth in the following sequence of steps:

1. Records on a database that are responsive to a particular query are sent incorporating into the map image at predetermined locations and then the information is transmitted to the user.

2. Icons responsive to the user input are displayed on the map

3. The user activates the embedded control function in the map

4. Information relating to the location of the accessed icon is transmitted to the map content provider.

5. If the results are from the database having a single record, the control function is redirects the browser to a new window where the text-based information is displayed.

6. If there is one record having responsive information, the control function redirects the browser to a page that displays the text-based information in the record.

Referring back to FIG. 11, a client computer 902 makes a request for a specific map at or URL 904. The URL is then parsed into component parts. For example “http” is the type of request, in this case a hypertext transport protocol. The path is sent to the web server as part of the HTTP GET line for getting and posting a requested address. The DNS 908, resolves the URL to a corresponding Internet Protocol address 910. The request 912 is routed from DNS 908 to the correct map server 914 for fulfillment of the request. Associated with the URL is a class or destination information 950. The destination information 950 can be on requested server 914, or alternatively the information could reside on a separate class server 916.

The requested information is sent over the Internet 918 along with the class server text-based information in the form of hypertext markup language (HTML). This is presented to the video monitor 920 of the client computer 902. A browser 922 parses the received information for content and formatting. Statements of other requests and images are made to the server via HTML 924. An applet 926, running on the client computer or on a server on the Internet may be run to place the advertisement and only the advertisement on the host computer's screen and to implement the various options for displaying the icon that contains the class or destinations information. The applet parses the page and sizes it for display. The applet 926 of FIG. 9 can be used to select and implement the control function within text.

While the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as a floppy disk, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiments that were chosen and described were to best explain the principles of the often invention, and the practical applications, and to enable others of ordinary skill in the art to understand the invention for various embodiments with various modifications as are suited to the particular use contemplated.

What is claimed is:

1. A system for searching for a selected class of destinations by geographic location comprising a server, said server in communication with a first database containing information relating to electronically displayed maps of regions, and in communication with a second database containing information relating to destinations, said second database containing information relating to a plurality of classes of destinations, and means to provide input to said server in the form of geographical locations and class destinations, wherein in response from input relating said class destination and input relating to a geographic location, and means to provide as an output a display of information in the form of a regional map having a plurality of icons, said regional map provided in response to said input from said input relating to said geographical locations and said icons provided in response to said input relating to said class destinations and said icons located at positions on said map at geographical locations representing the location of said destinations represented by said icon, and said icons further comprising control functions wherein the activation of said control functions provides a new display, said new display containing text-based information, said text-based information comprising information relating to said destination.

2. The system recited in claim 1 wherein said system is implemented on the Internet and said output is provided in HTTP and said new display comprises a new browser window.

3. The system recited in claim 1 wherein said system is implemented on the Internet and said output is provided in HTTP and said new display is revealed by a mouseover.

4. The system as recited in claim 2 wherein said browser window further comprises the presentation of hyperlinks to a new Internet site on the world wide web.

5. The system as recited in claim 1 wherein said destinations are selected from a predetermined list of destination classes.

6. A system for the display of text-based information relating to geographical locations by an information provider comprising providing means to received input of geographical and destination information, a database containing data relating to destinations and data relating to the visual representation of geographical locations, a program for searching said database based upon said input of destination and geographic input information, a program for correlating and destination information search results and geographic information search results in an output, said output further comprising a graphic representation of a map containing icons, said icons representing a graphic indicia of said destination search results, wherein the location of said icons are displayed on said graphic representation of a map at the geographical location of said destination results, said icon further comprising a control function, said control function that can be activated by a user and provide a second output, said second output comprising text-based information relating to the destination represented by said icon.

7. A system for the display of text-based information relating to geographical locations by an information provider on a personal computer comprising providing means to receive input relating to geographic region parameters and destination parameters, a first search program that searches for predetermined destinations within a selected geographical region based upon user input, a first output in the form of graphical display of a first map region containing icons, said icons representing a graphic indicia of output destinations having geographic locations and generated in response to said input relating to destination parameters, and said icon located and displayed on said map at said geographical location of said output destination, and a control function, said control function comprising a moveable search field, said moveable search field comprising a second defined geographic region within said first displayed map region and the location of said field controlled by said user, and in response to the activation of a second program function, text-based information relating to any said icons within a selected search field is displayed.

8. The system as recited in claim 7 wherein said means to receive input relating to geographical regions and destinations comprises a browser window on client and said client sends over a distributed network to a server that performs said first and said second said search functions on a first and second database, is first database containing and said second database, correlating said server correlates the results of first and said second result and transmit a display in response to said search functions over said distribution network to said client.

9. The system as recited in claim 7 wherein said destinations are comprised of a set of predetermined classes.

10. The system as recited in claim 1 wherein said text-based information is presented in a predetermined manner based upon a predetermined hierarchy that is implemented by information provider.

11. The system as recited in claim 10 wherein said predetermined hierarchy comprises preferred destinations selected by the information provider.

12. The system as recited in claim 10 wherein said hierarchy is determined by proximity to the geographic location input data.

13. The system as recited in claim 10 wherein the predetermined hierarchy is based upon alphabetical listing of destinations within said regional.

15. A method for displaying test-based information relating to a particular destination in response to a users search for a destination within a geographic region comprising receiving input from a user in the form of geographic and a class destination, searching a first database for an output in the form of a visual geographic display of a map correspondence to said geographic region, search a second database for any of the user selected destination classes within said geographic region, correlating said destination results with said regional results, and providing a icon at the said location, correlating said icon with text-based information relating to said icon.

16. A method of enabling an Internet user to associate text-based information with an icon representing a destination on an electronically displayed map comprising a first step of providing a first input field to allow a user to register and therefore gain access to a limited access second input field comprising a selection of a predetermined number of destination classes, in response to the selection of a class destination, providing a third input field for receiving text-based information relating to said destination, said information including the address of said location, correlating said input from said third input field to a regional geographic map containing the address provided in said third input field, associating an icon relating to said input from said third input field and in response to a subsequent input of data corresponding to said input data relating to geographic region and destination, providing an output containing a display of a regional map that includes an icon located at location of the address of said user created destination and said icon containing a function for accessing information that was provided by said user relating to said icon.

17. The method as recited in claim 16 wherein the display of said icon that was originated by said authorized user is limited to a predetermined time period and after the expiration of said predetermined time period, said icon is no longer displayed in response to correlated geographic and destination search inputs.
